(19) United States
(12) Patent Application Publication
(10) Pub. No.: US 2008/0120304 A1
(43) Pub. Date: May 22, 2008

(54) METHOD AND SYSTEM FOR PROVIDING HIGH PERFORMANCE DATA MODIFICATION OF RELATIONAL DATABASE TABLES

(76) Inventors: Robert J. Calio, Red Hook, NY (US); Isidore G. Bendrihem, Fort Lee, NJ (US)

Correspondence Address: F. Chau, Esq.;F. CHAU & ASSOCIATES, LLC, 130 Woodbury Road, Woodbury, CT, 11797, US

(21) Appl. No.: 11/562,078

(22) Filed: Nov. 21, 2006

(51) Int. Cl. G06F 17/30

(52) U.S. Cl. 707/10; 707/E17.032

(57) ABSTRACT

A method for updating a database, including connecting from a client to a database on a server, generating a temporary table on the server, wherein the temporary table is a copy of a target table from the database, storing client data into the temporary table as temporary table data, and updating of the target table based on the temporary table data.

### TECHNICAL FIELD OF THE INVENTION

The present disclosure relates generally to the field of computer databases, and more specifically to the insertion and update of bulk amounts of data into one or more relational database tables from clients.

### BACKGROUND

Inserting rows of data into one or more tables is a common task in virtually all modern client-server or Web based relational database applications. In distributed, multi-client transactional environments that directly insert tens of thousands of rows of data, performance and concurrency are of primary concern.

Performance may be measured as the duration of a transaction from the client's perspective. Remote database (RDB) transactions that directly insert into a target table can be a performance nightmare, taking many minutes to complete, particularly if the number of rows to be inserted exceeds ten thousand. Additional penalties are occurred with the presence of any defined triggers and/or indices.

Concurrency is a measure of how many clients can simultaneously access (read and/or write to) a given target table in the database. Other users could possible be denied access to the target table (deadlock) if the application fails to commit often enough or holds an exclusive lock on the target table for an extended period of time.

If the number of rows to be inserted from the client to a server is relatively small, say tens of rows, the task of insertion can be handled by a number of conventional methods. If however, there are many rows to insert, say tens of thousands, then the conventional methods suffer from various limitations.

One such conventional method requires each client to install database code locally and execute “load utilities” to insert the data into the target table. In this approach, while performance is not generally an issue, concurrency suffers greatly. The approach also suffers from authority and error handling issues.

Because the load utilities run from a privileged user, inserting data into a relational table using such utilities typically requires acquiring an exclusive lock on the target table. An exclusive lock on a table will prevent any level of access (including read-only) to the table for the duration of the load, reducing concurrency to one.

In many relational database systems, executing load utilities is reserved for privileged systems, executing load utilities is reserved for privileged users/system administrators and requires higher authority than what is usually granted to or required by general users. This may introduce undesirable side effects such as security issues.

An important aspect of an online, transactional system is the ability to recover from errors. If a load utility fails partially through a transaction, the database's normal error recovery processing is to rollback the entire transaction to the last consistency point. In some database systems, when a load fails, the table can be left in an unavailable state, requiring manual intervention by the database administrator to clear the error. Obviously, the situation will impact not only an immediate client, but also any other clients trying to access the table, reducing concurrency to zero.

The challenge is to achieve improved table concurrency and insert performance with minimal client authority in a distributed, thin client (no local database code) environment, with error retry capabilities.

### SUMMARY OF THE INVENTION

According to an exemplary embodiment of the present invention, a method for updating a database is provided. The method includes the steps of connecting from a client to a database on a server, generating of a temporary table on the server, wherein the temporary table is a copy of a target table from the database, storing client data from the client into the temporary table as temporary table data, and updating of the target table based on the temporary table data.

According to an exemplary embodiment of the present invention, a computer readable medium including computer code for updating a remote relational database is provided. The computer readable medium includes computer code for connecting from a client across a network to a relational database on a remote server, computer code for generating a temporary table on the server, wherein the temporary table is a copy of a target table from the database, computer code for storing client data from the client into the temporary table as temporary table data, and computer code for updating of the target table based on the temporary table data.

According to an exemplary embodiment of the present invention, a distributed database system is provided which includes a client having a communication program, a network, a server, and a relational database on the server. The client uses the communication program to store client data into a temporary table that mirrors a structure of the target table in the relational database as temporary table data and the target table is updated based on the target table data.

These and other exemplary embodiments, aspects, features and advantages of the present invention will be described or become more apparent from the following detailed description of exemplary embodiments, which is to be read in connection with the accompanying figures.

### BRIEF DESCRIPTION OF THE DRAWINGS

FIG. 1 is a high-level block diagram of a distributed database system according to an exemplary embodiment of the present invention.

FIG. 2 is flow chart which illustrates a method of modifying a remote table according to an exemplary embodiment of the present invention.

FIG. 3 illustrates a data flow diagram of an application which performs a process of inserting data into a database, according to an exemplary embodiment of the present invention.

FIG. 4 illustrates a system view and topology for insertion of data into a remote table according to an exemplary embodiment of the present invention.

FIG. 5 illustrates a process of inserting data into a database table according to an exemplary embodiment of the present invention.

FIG. 6 illustrates a process of updating data of a database table according to an exemplary embodiment of the present invention.

FIG. 7 illustrates a process of deleting data from a database table according to an exemplary embodiment of the present invention.

### DETAILED DESCRIPTION OF EXEMPLARY EMBODIMENTS

In general, exemplary embodiments of the invention as described in further detail hereafter include systems and methods which facilitate mass data update of tables in databases and offer improved performance and higher concurrency.

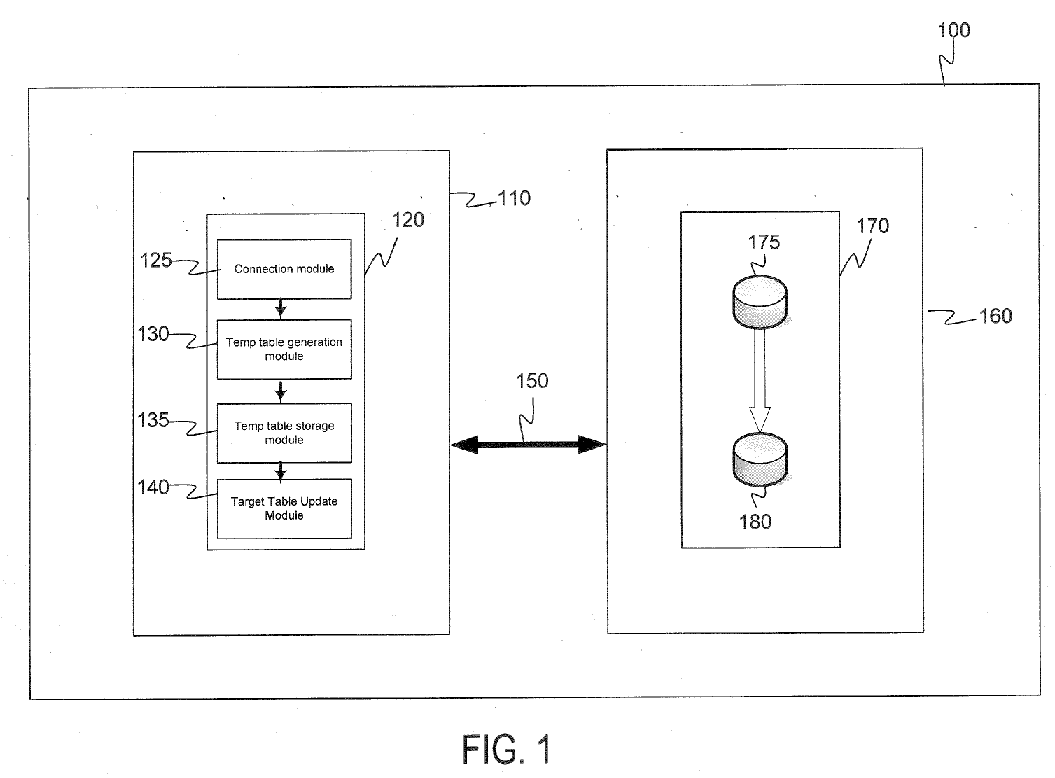

Exemplary systems and methods for systems and methods which facilitate mass data update of tables in databases will now be discussed in further detail with reference to illustrative embodiments of FIGS. 1-7. It is to be understood that the systems and methods described herein my be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

FIG. 1 is a high-level block diagram of a distributed database system 100 according to an exemplary embodiments of the present invention. Referring to FIG. 1, the distributed database system includes a client 110 connected to a server 160 through a network 150. The client 110 includes a data transfer module 120. The data transfer module 120 includes a connection module 125, a temp table generation module 130, a temp table storage module 135, and a target table update module 140. The server 160 includes a database 170. The database 170 includes a temp table 175 and a target table 180. The temp table 175 is created by the temp table generation module 130. The connection module 120 opens up a connection to the database 170. The temp table generation module 130 makes a copy of the structure of the target table 180 to generate the temp table 175. The temp table storage module 135 copies data from the client into the temp table 175. The target table update module 140 updates data in the target table using the data in the temp table 175. The updates may include any number of SQL inserts, updates, deletes, and combinations thereof.

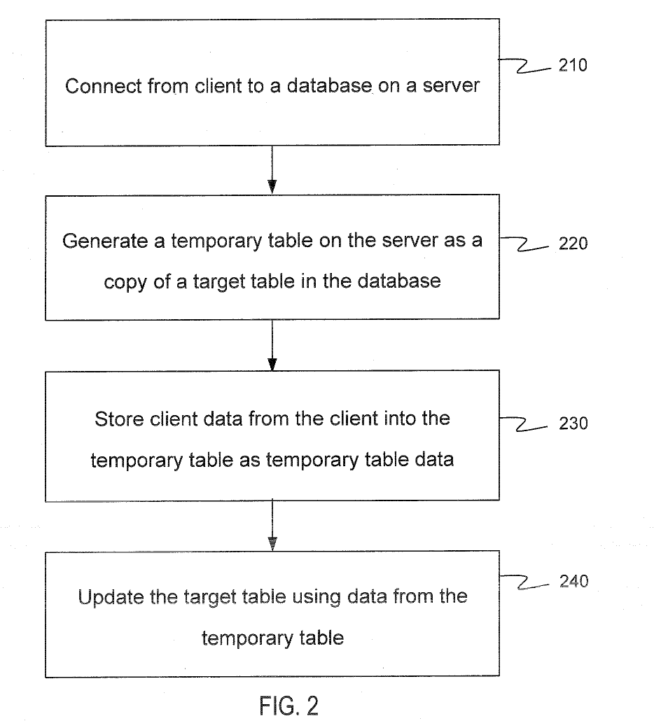

FIG. 2 is a flow chart which illustrates a method of modifying a remote table according to an exemplary embodiment of the present invention. Referring to FIG. 2, in a step 210, a client connects to a database on a server. The database may be a relational database such as IBM DB2, Oracle, Sybase, Informix, Microsoft SQL Server, Microsoft Access, etc. The connection may be made from a remote client across a network to a remote server.

In a step 220, the client generates a temporary table on the server. The temporary table is a copy of target table in the database. The temporary table does not include the rows of data of the target table, but does include the same column headings as the target table. Essentially, the temporary table is a blank copy of the target table.

The temporary table may be a declared temporary table (DGTT) which is created at runtime. The DGTT acts as a private buffer and effectively gives a user a personal sandbox to work in. Unlike regular tables, a DGTT is not registered in the database system catalog. This saves time when the table is created. The DGTT is also “invisible” to other users, and accordingly does not introduce any concurrency issues. In fact, the DGTT may not be accessible to any other user/application. Additionally, the transactions (inserts, updates, deletes) performed on the DGTT are not logged in the transaction log of the database, reducing the time it takes to insert, update, or delete rows of data and improving performance.

In a step 230, the client stores client data into the temporary table. The data may be transferred from the client by using one or more SQL (structured query language) or DML (data manipulation language) statements. The data may derive from a number of sources including a flat file, memory, manual entry, etc. The storing of data can proceed over a period of time and include multiple operations such as inserts, updates, deletes, and combinations thereof.

After the client has completely loaded the DGTT, data from the DGTT is ready to be used to update the target table in a step 240. At this point, the data in the DGTT can easily be “cleansed” or prepared in any desired way, with little or no network traffic and reduced exposure to deadlock, since all work is done in complete isolation and with not logging. The updating of the target table can be accomplished by using simple (or complex) SQL or DML statements and the work may be done on the server, with little or no network traffic required.

If the updating of the target table using data from the DGTT fails for any reason, the entire transaction can be rolled back and re-tried after a pre-determined period of time and any number of times. As long as the DGTT has not been destroyed, the data still resides of the server and does not need to be transferred from the client again.

Upon successful movement of data from the DGTT to the target table, the DGTT can be dropped. An application implementing the method may destroy the DGTT when it disconnects from the database if the DGTT is no longer of any use.

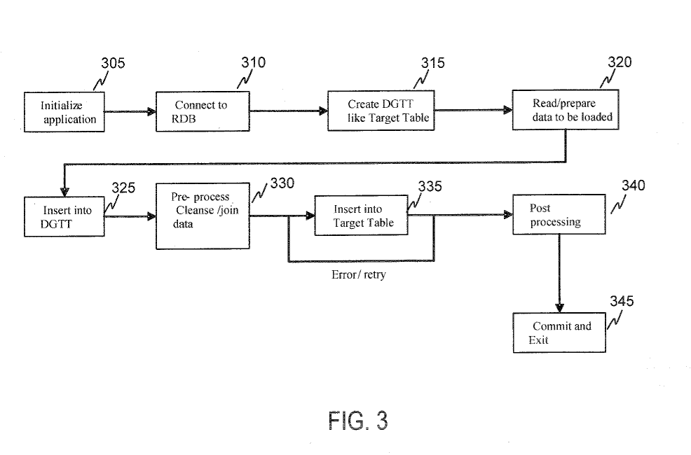

FIG. 3 illustrates a data flow digram of an application which performs a process of inserting data into a database, according to an exemplary embodiment of the present invention. Referring to FIG. 3, in a step 305, the application performs an initialization to get required information. This initialization may include a number of steps including for example, retrieving the address and name of the server the database resides on, the name of the database, the name of a target table, the name of a flat file which may be used to load a temporary table, etc.

In a step 310, the application makes a database connection to the database using the information retrieved during the prior step. In a step 315, a declared global temporary table (DGTT) is created as either a modified or exact copy of the target table. An exact copy means that the copied table mirrors the structure of the target table, having the same column headings but is devoid of rows of data. A modified copy means that the copied table only mirrors a portion of the target table, possible having less column headings, and again is devoid of any data. In a step 320, data is read in from a file or created in core and prepared for insert into the DGTT. In a step 325, the data is inserted into the DGTT. In a step 330, pre-processing of the data in the DGTT is performed if necessary. The preprocessing may include cleansing or joining of the data in the DGTT. In a step 335, the data from the DGTT is inserted into the target table. In a step 340, post-processing of the data in the target table is performed if it is required. In step 345, the changes are committed to the database and the application exits.

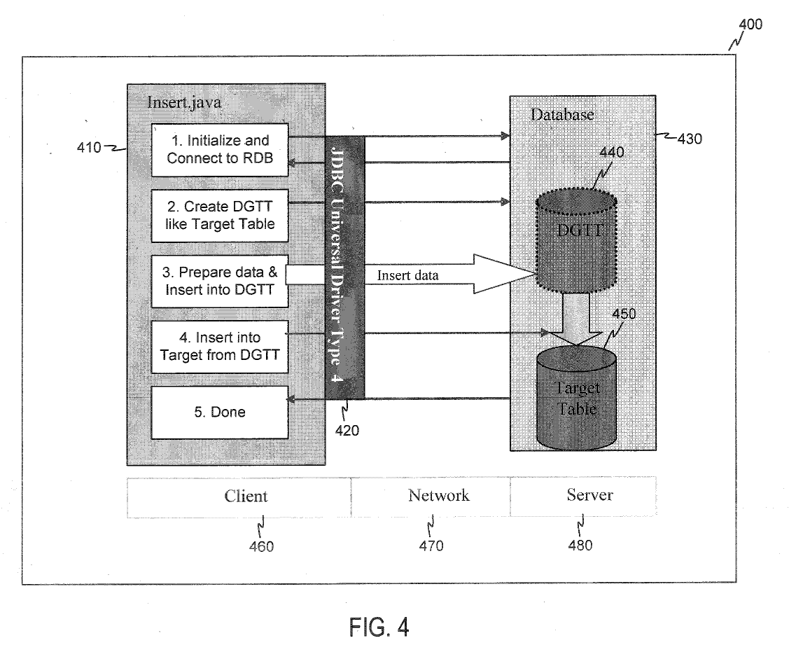

FIG. 4 illustrates a system view and topology for insertion of data into a remote table according to an exemplary embodiment of the present invention. Referring to FIG. 4, the system includes a client 460, a network 470, and a server 480. A java program 410 named “Insert.java” runs on the client. The java program 410 illustrated is merely an example, as its name and contents can vary considerably. While the illustrated java program 410 only performs inserts, it can easily be modified to perform any inserts, updates, deletes, and combinations thereof as required. The present invention is not limited to java, as any other appropriate language may be used such as C++, etc.

The server 480 has a database 430 which includes a DGTT 440 and a target table 450. The client 460 makes use of a JDBC Universal Driver Type-4 420 as a means of accessing the database 430 on the server 480. While a JDBC Universal Driver Type-4 is illustrated in FIG. 4, the present invention is not limited to JDBC Type-4, as any other appropriate driver may be used such as JDBC Type-2, non-JDBC drivers, or even native client connection mechanisms.

JDBC stands for Java Database Connectivity and it is a Java Application Interface (API) for executing SQL statements. It includes a set of classes and interfaces written in the Java programming language. JDBC provides a standard API for tool/database developers and makes it possible to write database applications by using a pure Java API. The java program 410 can communicate directly with the database 430. However, this requires a JDBC driver that can communicate with a particular database management system being accessed.

A JDBC driver is used to open a connection to a database via a JDBC driver, which must register with a driver manager before the connection can be formed. FIG. 4, illustrates a JDBC type-4 driver 420 as an embodiment of the JDB driver.

A JDBC type-4 driver (also known as a native protocol driver) is a database driver implementation that converts JDBC into a vendor specific database protocol. The type-4 driver is written completely in Java and is platform independent. It is installed inside the Java Virtual machine (JVM) of the client. It provides better performance over the type-1 and type-2 drivers as it does no have the overhead of conversion of calls into ODBC (Open Database Connectivity) or database API calls. Unlike the type-1 and type-2 drivers, type-4 does not need associated software to work.

The Java program 410 gets connection information during its initialization and connects to the database 430. The transaction specific parameters can be read from the command line switches or created on the fly. The Java program 410 declares a DGTT 440 as an exact copy or a modified copy of the structure of the target table 450. The exact copy has the same column headings as the target data, but is devoid of rows of data. The modified copy of the table may have less columns than the target table 450, and again is devoid of data.

Data to be inserted into the DGTT 440 can be read from various input streams such as a file, from a pipe (stdin), or created on the fly. The data may be inserted as rows into the DGTT 440 using a Prepared Statement. A Prepared Statement contains SQL statements that a database to compile those statements. Data in the DGTT 440 may also be inserted, updated or deleted using the Prepared Statement.

When database operations including inserts, deletes, and updates are performed on the DGTT 440, no transaction logging takes place, thereby improving performance. In addition, the use of the DGTT 440 improves the concurrency of the target table 450. Database operations that would normally be performed on the target table 450, which would lock aspects of the target table 450 and reduce concurrency, are offloaded to the DGTT 440.

To further improve the speed of processing, the “Batch” processing feature of JDBC may be used to batch N number of inserts instead of doing them one at a time. The “Batch” processing feature may also be used for mass updates and deletes. If an error occurs while inserting data into the DGTT 440, error processing can take place solely on the DGTT 440, leaving the target table 450 untouched. If no errors are encountered, a commit statement can be used to save the rows of data in the DGTT 440. Work (e.g., calculations and sorting) can be performed on the DGTT 440 in isolation of the target table 450.

The data in the DGTT 440 may be used to perform any necessary SQL inserts, updates, and deletes on the target table 450. Since these operations take place on the target table 450, transaction logging does occur. However, since most of the work is performed on the server, there is minimal network traffic.

If an error occurs while modifying the target table 450 using data from the DGTT 440, the modifications can be re-tried after a predefined period of time. This re-trying can be performed periodically until a success results since the DGTT 440 retains its copy of the data. Any necessary post-processing (i.e., fire off application event/trigger) can also be performed. When all the desired changes to the target table 450 have been made, the changes can be committed. When the DGTT 440 is no longer of any use, it can be dropped from the database 430.

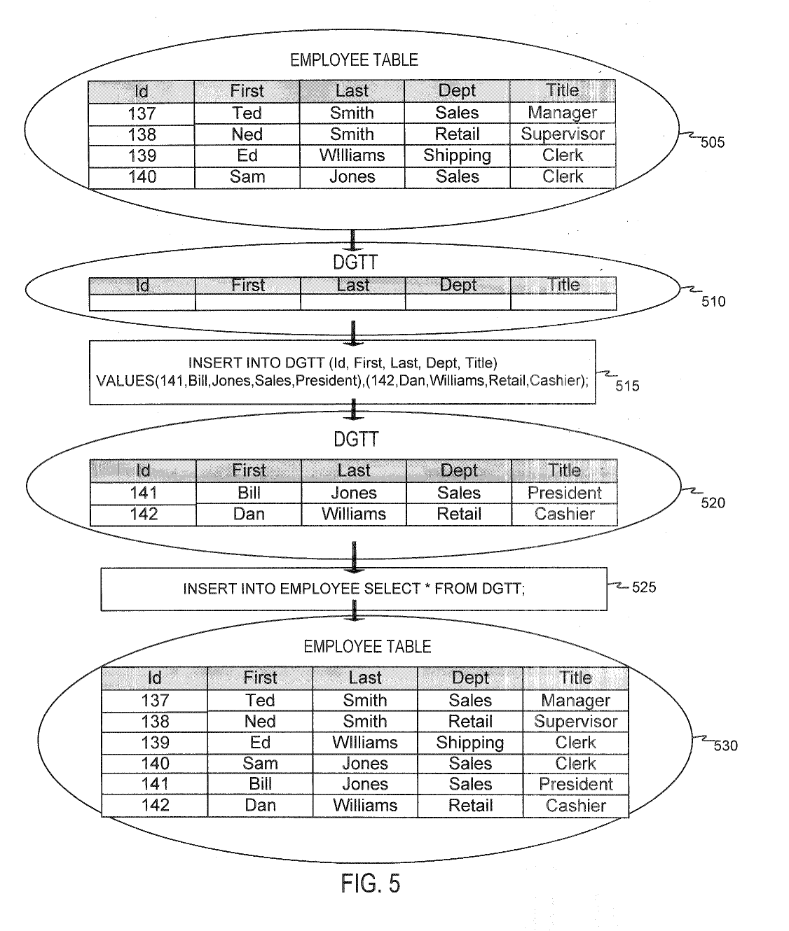

FIG. 5 illustrates a process of inserting data into a database table according to an exemplary embodiment of the present invention. Referring to FIG. 5, initially an EMPLOYEE table has five column headings and four rows of data 505. A first SQL statement is then executed 515 and employees “Bill Smith” and “Dan Williams” are inserted as two rows of data into the DGTT 520. Next a second SQL statement is executed 525 and the rows of data from the DGTT are inserted into the EMPLOYEE table 530.

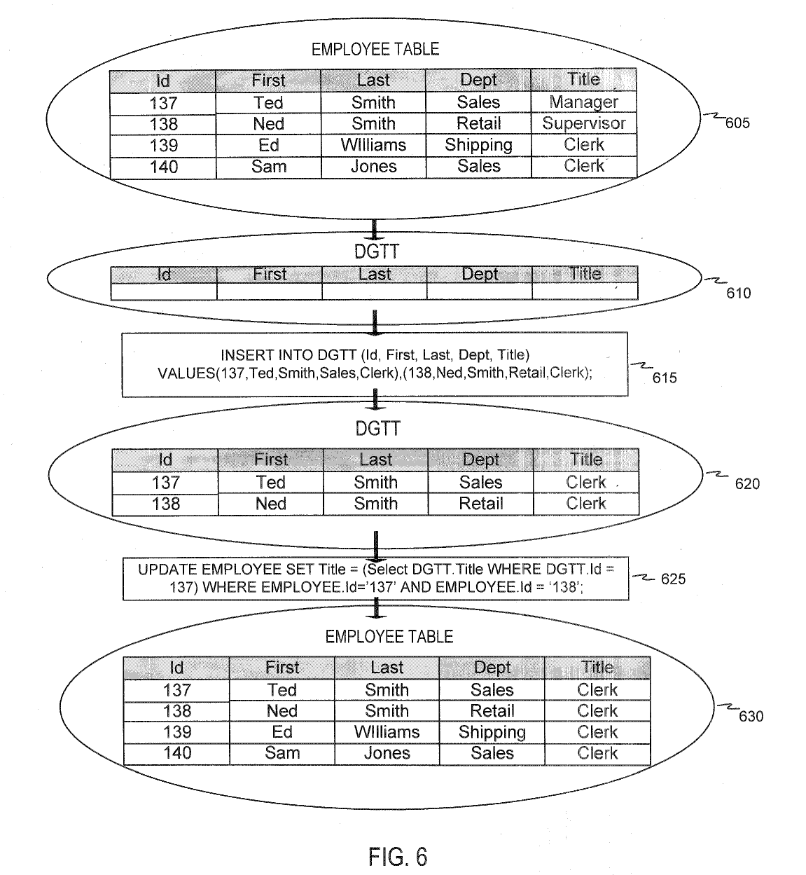

FIG. 6 illustrates a process of updating data of a database table according to an exemplary embodiment of the present invention. Referring to FIG. 6, initially an EMPLOYEE table has five column headings and four rows of data 605. A DGTT is created as a blank copy of the employee table 610. A first SQL statement is then executed 615 and revised data for the title of two existing employees is inserted as two rows of data into the DGTT 620. Next a second SQL statement is executed 625 and the title of the two employees in the EMPLOYEE table is updates with the data from the DGTT 630.

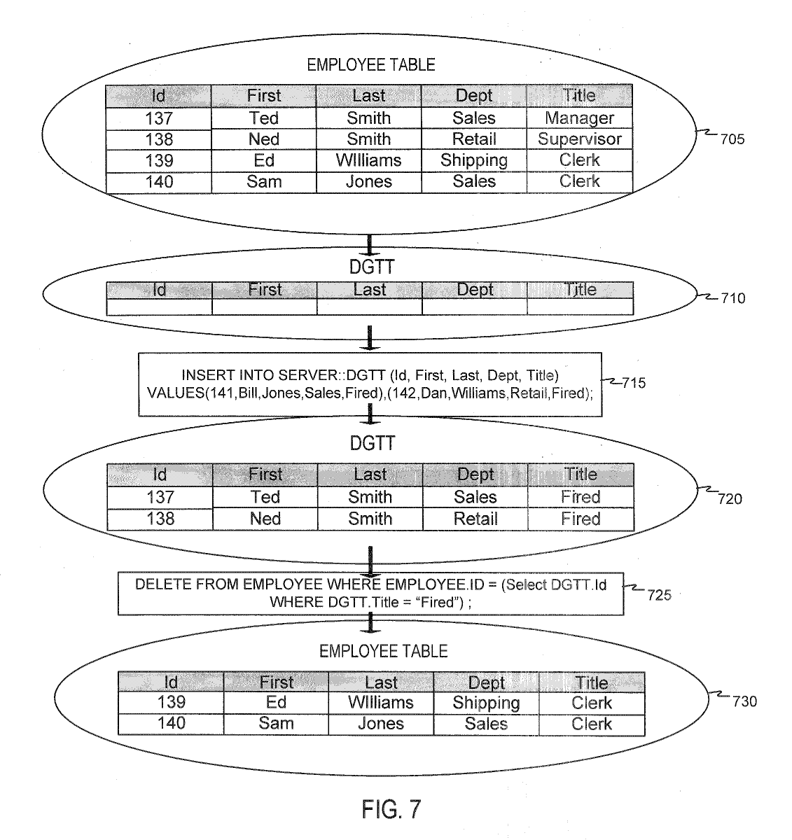

FIG. 7 illustrates a process of deleting data from a database table according to an exemplary embodiment of the present invention. Referring to FIG. 7, initially an EMPLOYEE table has five column headings and four rows of data 605. A DGTT is created as a blank copy of the employee table 610. A first SQL statement is then executed 615 and revised data regarding the employment status of two employee is inserted as two rows of data into the DGTT 620. Next a second SQL statement is executed 625 and the two employees which match those listed as “fired” are deleted from the EMPLOYEE table in the DGTT 630.

The data used to update the DGTT's illustrated in FIGS. 5-7 may be supplied by a remote client. The EMPLOYEE tables and DGTTs illustrated may be stored in a database of a server remote to the client. The client may use a JDBC connection protocol to connect to the database and for insertions, updates, and deletes of the DGTTs and the EMPLOYEE tables. Although FIGS. 5-7 illustrates two inserts, two updates, and two deletes, respectively, these are merely exemplary embodiments. The present invention is not limited to only two operations, as any number of inserts, updates, deletes, and combinations thereof may be performed on any number of database tables.

In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary , the intention is to cover all modifications, equivalents, and alternatives falling within the spirit and scope of the invention as defined by the appended claims. It should be understood that the systems and methods described herein may be implemented in various forms of hardware, software, firmware, or a combination thereof.

The particular embodiments disclosed above are illustrative only, as the invention may be modified and practices in different but equivalent manners apparent to those skilled in the art having the benefit of the teachings herein. Furthermore, no limitations are intended to the details of design shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for updating a database, comprising:
connecting from a client across a network to a database on a server;
generating a temporary table on the server, wherein the temporary table is a copy of a target table from the database;
storing client data into the temporary table as temporary table data; and
updating the target table based on the temporary table data.

2. The method of claim 1, wherein the database is a relational database.

3. The method of claim 1, wherein the copy is empty of data and has the same data column headings as the target table.

4. The method of claim 2, wherein the storing and updating are performed using one or more SQL or DML commands.

5. The method of claim 1, wherein the updating of the target table is re-tried after a predetermined period of time, if the updating fails.

6. The method of claim 2, further comprising committing changes to the database associated with the updating of the target table.

7. The method of claim 2, wherein the storing and updating are performed using one or more prepared statements.

8. The method of claim 2, wherein the connecting from the client uses a JDBC connection protocol.

9. The method of claim 8, wherein the storing and updating are performed using a batch processing feature of the JDBC connection protocol.

10. The method of claim 8, wherein the method is implemented as a java program.

11. The method of claim 2, wherein the temporary table is a declared global temporary table.

12. A computer readable medium including computer code for updating a remote relational database, comprising:
computer code for connecting from a client across a network to a relational database on a remote server;
computer code for generating a temporary table on the server, wherein the temporary table is a copy of a target table from the database;
computer code for storing client data from the client into the temporary table as temporary table data; and
computer code for updating of the target table based on the temporary table data.

13. The computer readable medium of claim 12, wherein the copy matches a structure of the target table but is devoid of data.

14. A distributed database system, comprising:
a client having a communication program;
a network;
a server; and
a relational database on the server, wherein the client uses the communication program to store client data into a temporary table that mirrors a structure of the target table in the relational database as temporary table data and the target table is updated based on the target table data.

15. The distributed database system of claim 14, wherein the communication program connects to the relational database across the network using a JDBC connection protocol.

16. The distributed database system of claim 15, wherein the client includes a JDBC Universal Driver Type-4.

17. The distributed database system of claim 14, wherein if a failure results when the target table is updated, the update of the target table is re-tried after a predetermined period of time.

18. The distributed database system of claim 14, wherein the communication program commits change to the relational database after the target table is successfully updated.

19. The distributed database system of claim 14, wherein the storing of the client data and the updating of the target table comprise one or more prepared statements.

20. The distributed database system of claim 15, wherein the storing of the client data and the updating of the target table are performed using a batch processing feature of the JDBC connection protocol.
